(19) United States
(12) Patent Application Publication
(10) Pub. No.: US 2008/0222944 A1
(43) Pub. Date: Sep. 18, 2008

(54) Fire ant colony killer

(76) Inventor: Ken McDonald, Gainesville, TX (US)

Correspondence Address: Arthur W. Fisher;Patent Dominion Partnership LP, 6103 Twin Oaks Circle, Dallas, TX, 75240, US

(21) Appl. No.: 12/156,009

(22) Filed: May 30, 2008

Related U.S. Application Data
(63) Continuation-in-part of application No. 11/652,296, filed on Jan. 12, 2007.

(51) Int. Cl. A01M 5/00

(52) U.S. Cl. 43/138

(57) ABSTRACT

A mechanized exterminator and several embodiments thereof are presented. A support disc with rollers attached rotates when power is applied causing rollers to roll over a base. The operation of the of the exterminator disturbs the insects causing them to enter the exterminator where the rollers will crush them. Solar, battery and/or wind power can be used to power the exterminator. The exterminator is cost-effective and environmentally safe. The exterminator severely impacts the strength and health of the colony minimizing its ability to reproduce.

### CROSS REFERENCES TO RELATED APPLICATIONS

The present application is a Continuation-in-Part application of U.S. patent application Ser. No. 11/652,296 filed on Jan. 12, 2008 and also entitled “Fire Ant Colony Killer.”

### BACKGROUND OF THE INVENTION

### Description of the Related Art

Insect extermination, particularly for undesirable external insects, has been largely confined to chemical treatments. Zappers are used for certain flying insects. These chemical treatments are often ineffective and always create environmental and health concerns.

Fire ants, in particular, are very aggressive and their bites are always hurtful and sometimes dangerous. The usual result from a chemical treatment is that the colony relocates. Often, they become even more aggressive as a result.

Thus, there is a need in the art for a method and apparatus for a cost efficient and truly effective system for exterminating insects, particularly fire ants.

There is also a need in the art for a method and apparatus for exterminating insects which is non-chemical and completely safe both environmentally and from a health perspective.

### SUMMARY OF THE INVENTION

Apparatus for a mechanized exterminator comprising a housing; a motor having a drive shaft and disposed within the housing; a support means coupled to the drive shaft and having one or more rollers coupled thereto, a base having a surface; means for coupling the base to the drive shaft such that when so coupled, the housing and the support means rotate and the rollers roll over the surface of the base; and wherein the operation of the exterminator in proximity to the insects disturbs the insects causing the insects to get on the surface of the base where the rollers will roll over and crush them.

The apparatus for an exterminator as described above wherein the exterminator is configured as a two-piece unit comprising a first piece comprising the housing with the motor and drive shaft coupled to the support means; and a second piece comprising the base and the means for coupling the base to the drive shaft.

The apparatus for an exterminator as described above wherein the means for coupling the base to the drive shaft comprises a slot in the base configured such that the drive shaft can be inserted therein.

The apparatus for an exterminator as described above wherein the first piece further comprises a power source for the motor.

The apparatus for an exterminator as described above wherein the power source is one or more solar cells disposed on the housing.

The apparatus for an exterminator as described above wherein the power source is one or more batteries disposed within the housing.

The apparatus for an exterminator as described above wherein one or more of the batteries are re-chargeable

The apparatus for an exterminator as described above wherein the power source is one or more batteries disposed within the housing and one or more solar cells disposed on the housing.

The apparatus for an exterminator as described above further comprising one or more solar cells disposed on the housing and wherein one or more of the solar cells re-charges the re-chargeable batteries.

The apparatus for an exterminator as described above further comprising a solar cell power source for the motor and a voltage regulator coupled to the solar cell for maintaining a consistent voltage output from the solar cell.

The apparatus for an exterminator as described above further comprising one or more drainage holes through the base for discharging rain and other moisture from the exterminator.

Apparatus for a mechanized exterminator comprising a motor having a drive shaft; a base having a surface; a support means coupled to the drive shaft and having one or more rollers coupled thereto and disposed in close proximity to the base; a wind power device for providing power; a generator coupled to the wind power device and coupled to the motor, the generator converting mechanical energy from the wind power device into electrical energy for the motor; and wherein the operation of the exterminator in proximity to the insects disturbs the insects causing the insects to get on the surface of the base where the rollers will roll over and crush them.

The apparatus for an exterminator as described above further comprising one or more batteries for additional power for the motor and/or for voltage regulation of the electrical power to the motor.

The apparatus for an exterminator as described above wherein one or more of the batteries is re-chargeable.

The apparatus for an exterminator as described above further comprising one or more solar cells for additional power for the motor.

The apparatus for an exterminator as described above further comprising one or more solar cells for additional power for the motor and/or recharging of the re-chargeable batteries.

The apparatus for an exterminator as described above further comprising one or more drainage holes through the base for discharging rain and other moisture from the exterminator.

The apparatus for an exterminator as described above further comprising a third piece, said third piece including a wind power device and a generator for converting mechanical energy from the wind power device and coupling means for transferring electrical energy from the generator to the motor.

The apparatus for an exterminator as described above wherein the wind power device and the generator form a power unit and the motor, base, and support means form a base unit and wherein a single power unit may be used to power a plurality of base units.

The apparatus for an exterminator as described above wherein the power unit is remotely located from the base units

### BRIEF DESCRIPTION OF THE DRAWINGS

FIG. 1a is a cross-sectional view of one piece of mechanized insect exterminator.

FIG. 1b is a cross-sectional view of a second piece of the mechanized insect exterminator.

FIG. 1c is a top view of the mechanized exterminator in which the pieces of FIGS. 1a and 1b have been combined.

FIG. 2 is a cross-sectional view of a wind powered mechanized insect exterminator.

FIG. 3a is a cross-sectional view of a third piece of a wind powered mechanized insect exterminator.

FIG. 3b is a cross-sectional view of a first and a second piece coupled together to operate with the third piece of FIG. 3a.

### DETAILED DESCRIPTION

Whilst the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not limit the scope of the invention. Moreover, the present invention, while described for the extermination of fire ants and fire ant colonies, may be utilized to exterminate a wide variety of insects.

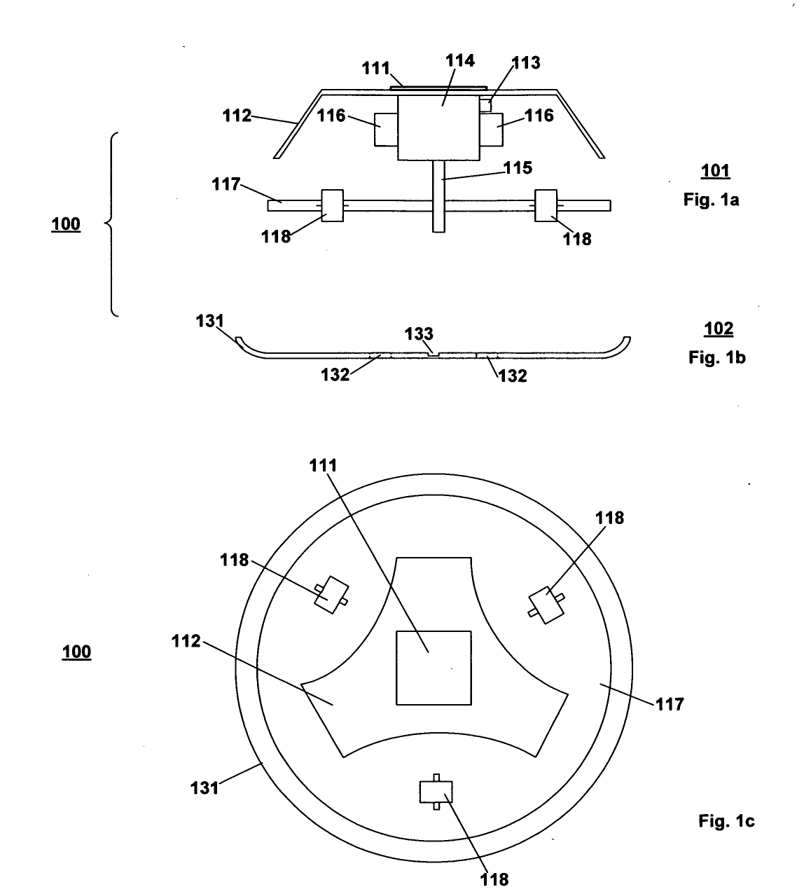

Referring now to FIG. 1a, a cross-sectional view of a first piece of 101 the mechanized exterminator 100 is depicted. A solar cell 111 is embedded on the top of a housing 112. Within the housing 112 are depicted a voltage regulator 113, a motor 114 with a drive shaft 115 and batteries 116. The solar cell 111, voltage regulator 113, motor 114 and batteries 116 are electrically connected. The first piece of the mechanized exterminator 100 also includes a support disc 117 secured to the motor drive shaft 115. The support disc 117 has a plurality of rollers 118 secured thereto.

Referring now to FIG. 1b a cross-sectional view of a second piece of 102 of the mechanized exterminator 100 is depicted. The second piece 102 includes a circular base 131 with a plurality of holes 132 and a slot 133. The slot 133 is preferably located at the center-point of the base 131. The base 131 may be constructed out of metal, plastic and/or a wide variety of other materials. The base 131 functions as both a base for the exterminator and also to provide a hard, smooth surface for rollers 118 to roll over and crush insects in the pathway of the rollers 118. The curved end or circumference of the base 131 serves to retain the dead bodies of the insects after crushing for easy disposal/clean-up. It will be appreciated, however, that base 131 may be of any shape and that the circumference or perimeter may be flat or any shape and remain within the scope of the present invention.

The plurality of holes 132 are drainage holes for the purpose of discharging rain or other moisture from the exterminator 100. The slot 133 is configured to accept the end of the motor drive shaft 115. In operation, when the end of the motor drive shaft 115 is inserted into the slot 133, the first piece 101 will rotate causing rollers 118 to move over the base in a circular pattern, crushing any insects that are in their pathway over the base 131.

Referring back to FIG. 1a, the motor 114 is preferably a low-speed, DC voltage motor. Specifically, it is preferable to have the first piece 101 rotating low-speed, 4-6 rpm for example, for best results. In one embodiment of the present invention, the solar cell 111 provides the power for the motor 114 and the batteries 116 and voltage regulator 113 are not needed. In yet another embodiment of the present invention, a voltage regulator 113 is used in addition to the solar cell 111, to maintain a constant voltage to the motor 114 and the batteries are not needed. In a third embodiment of the present invention, one or more batteries 116 are used to power the motor 114 and the solar cell 111 and regulator 113 are not used. In yet a fourth embodiment of the present invention, the batteries are re-chargeable and the solar cell 111 is used for power to the motor 114 and charging of the batteries during sunlight conditions and the batteries 116 used to power the motor when there is insufficient sunlight. In this fourth embodiment, the batteries can act as a natural voltage regulator for the solar cell such that regulator 113 is not needed.

The housing 112 may be a any suitable size, shape and material. The housing 112 may be fully enclosed or may have an open bottom. In FIG. 1a, the motor 114 is secured within the housing underneath the top surface. The batteries 116 are fastened to the motor 114 casing as is the voltage regular 113.

The motor drive shaft 115 extends through the support disc 117. The support disc is securely fastened to the motor drive shaft 115. As shown depicted in FIG. 1a, the support disc 115 is a circular disc of clear plastic. It will be appreciated that any number of materials and or shapes may be used for the support disc 115. A plurality of slots 134 are cut through the support disc and fitted with mounting holes so that rollers may be assembled within the slots and configure to roll over the base 131 when the first piece 101 and the second piece 102 are joined together.

Referring now to FIG. 1c, a top view of the exterminator 100 is depicted with the first piece 101 and the second piece 102 joined together. The end of the motor shaft 115 is inserted into slot 133 in the second piece 102. When power is applied to the motor 114, the first piece 101 will rotate. The height of the support disc 117 above the base 131 is such that the rollers 118 lay flush against the surface of the base 131 and roll over such surface when power is applied to the motor 114.

In FIG. 1c, the housing 112 is star-shaped so that more of the base surface is visible through the clear plastic support disc 117. Three rollers 118 are depicted. It will be appreciated that any number of rollers 118 may be used. It is preferable that the rollers 118 all be at the same distance from the center point of the support disc 117 and spaced an equiangular distance apart.

In operation, one or more mechanized exterminators 100 are placed directly on top of one or more insect colonies such as a fire ant colony. When power is applied to the motor 114, the rollers 118 begin to roll over the base 131 in a circular path. The noise and the vibration of the mechanized exterminator 100 disturbs the colony of fire ants causing the worker ants in the colony to become more aggressive and thereby attracting them on to the base 131. To speed up the process, it may be desirable to scratch the mound surface with a rake or stick just before the exterminator(s) are placed on the mound. The curved circumference or perimeter of the base 131 is no deterrent at all in this agitated/aggressive state. As the ants move toward the source of the disturbance, the rollers 118 roll over them and crush them. After an appropriate time depending on the size of the colony, weather, etc., the health and strength of the colony will have been so diminished as to severely impact their ability to reproduce.

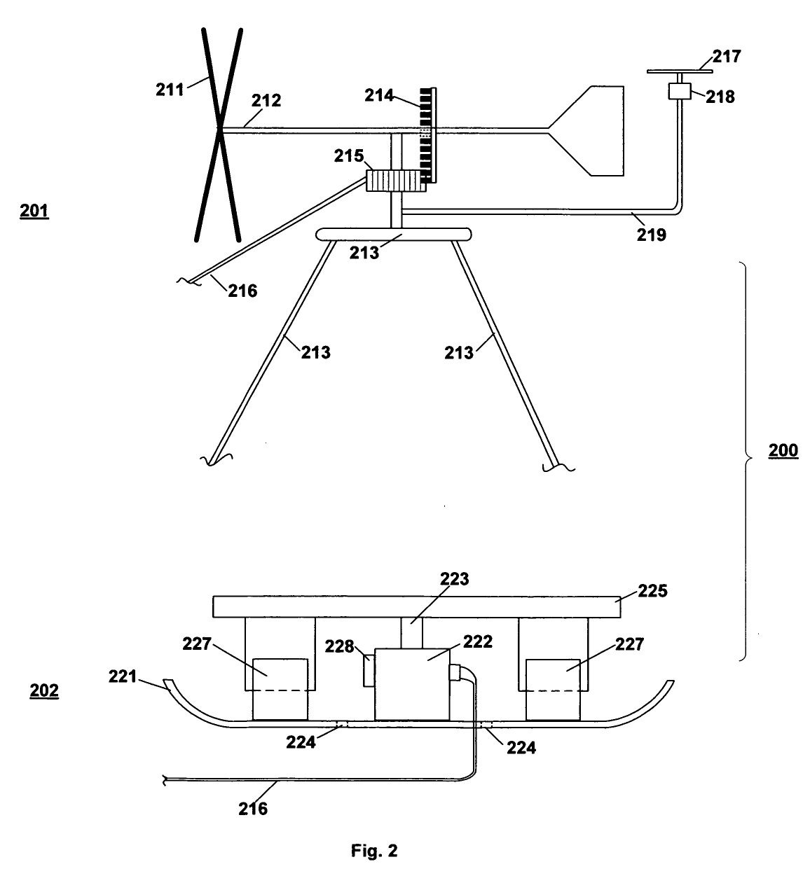

Referring now to FIG. 2, yet another embodiment of the mechanized insect exterminator 200 is depicted. The exterminator 200 operates similarly to exterminator 100 in FIGS. 1a and 1b except that it is powered by wind. In FIG. 2, a schematic diagram of a wind power device 201 and a cross-sectional view of a base unit 202 are depicted

The wind powered device 201 consists of blades 211 coupled to an axel 212 and supported by a frame 213. Wind applied to the blades 211 results in a rotation of axel 212. A geared cam 214 or other suitable device is fastened to the axel 212 and also rotates. The cam 214 engages a generator 215 which converts the mechanical energy from cam 214 to electrical energy. Wires 216 conduct the electricity from the generator 215 to the motor 222 in base unit 202. It will be appreciated that any suitable wind power device may be used within scope of the present invention.

The base unit 202 consists of a base 221. A motor 222 is secured to the base such that its drive shaft 223 is approximately at the mid-point of the base 221. The base 221 has a plurality of holes 224 for drainage of rain and moisture. A support disc 225 is secured to the drive shaft 223. The support disc 225 is configured with a plurality of rollers 227 which rest flush against the surface of the base 221. When electrical power is applied to the motor 222 from the generator 215, the support disc 225 will rotate causing the rollers 227 to roll over the surface of base 221 and crush any insects in its path. As with exterminator 100, the operation of the base unit, when placed on a mound of fire ants, for example, disturbs the fire ants causing them to become agitated and aggressive and to approach or attack the source of the disturbance.

In another embodiment of the present invention, one or more batteries 228 can be secured to the motor 222 and electrically connected thereto for additional power and to act as a natural voltage regulator for generator 215.

In yet another embodiment, one or more solar cells 217 can be added for additional power and a voltage regulator 218 for regulating the voltage to the motor 222 may be added to the exterminator 200. In FIG. 2, the solar cells 217 and voltage regulator 218 are shown coupled to the wind power device 201 by means of a support arm 219, it will be appreciated that they can also be attached to the base unit 202 or remotely from both the base unit 202 and the wind power device 201.

It will be further appreciated that one wind power device 201 may be used to power a plurality of base units 202.

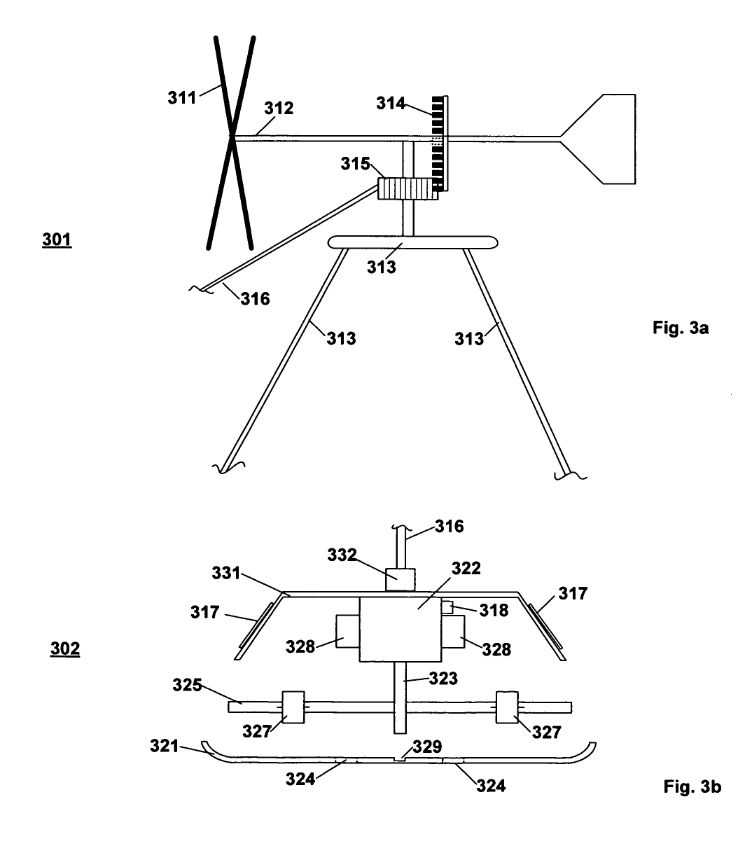

FIGS. 3a and 3b depict another embodiment of the exterminator 200 in FIG. 2. Specifically, as depicted in FIG. 3a, the wind powered device 301 which is similar to the wind power device 201 in FIG. 2, is used with the base unit 302 in FIG. 3b which is similar to the 2 piece exterminator 100 in FIGS. 1a and 1b.

FIG. 3a depicts a wind powered device 301 with a frame 313, blades 311, axel 312, cam 314 generator 315 and wires 316.

In FIG. 3b, the base unit 302 has been modified by re-locating solar cells to the side panels of housing 331. On top of the housing 331, a coupling device 332 has been added which electrically connects the electrical power from generator 315 to motor 322 without distorting the wires 316 from the generator 315 by the rotation of the housing 331. It can be appreciated that it will be obvious to one skilled in the art that a variety of methods are available to construct this coupling 332. It will be further appreciated that the solar cells 317, voltage regulator 318 and batteries 328 are optional.

The remainder of base unit 302 includes motor 322, drive shaft 323, support disc 325, rollers 327, base 321, drainage holes, 324, and drive shaft slot 329.

It will be appreciated that any number of designs and configurations for a wind powered drive mechanism are within the scope of the present invention and that the design depicted in FIGS. 2 and 3a are merely illustrative.

Thus, the present invention has been described herein with reference to particular embodiments for particular applications. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A mechanized exterminator for insects comprising:
a housing;
a motor having a drive shaft and disposed within the housing;
a support means coupled to the drive shaft and having one or more rollers coupled thereto,
a base having a surface;
means for coupling the base to the drive shaft such that when so coupled, the housing and the support means rotate and the rollers roll over the surface of the base; and
wherein the operation of the exterminator in proximity to the insects disturbs the insects causing the insects to get on the surface of the base where the rollers will roll over and crush them.

2. The exterminator of claim 1 wherein the exterminator is configured as a two-piece unit comprising:
a first piece comprising the housing with the motor and drive shaft coupled to the support means; and
a second piece comprising the base and the means for coupling the base to the drive shaft.

3. The exterminator of claim 1 wherein the means for coupling the base to the drive shaft comprises;
a slot in the base configured such that the drive shaft can be inserted therein.

4. The exterminator of claim 2 wherein the first piece further comprises a power source for the motor.

5. The exterminator of claim 4 wherein the power source is one or more solar cells disposed on the housing.

6. The exterminator of claim 4 wherein the power source is one or more batteries disposed within the housing.

7. The exterminator of claim 6 wherein one or more of the batteries are re-chargeable.

8. The exterminator of claim 4 wherein the power source is one or more batteries disposed within the housing and one or more solar cells disposed on the housing.

9. The exterminator of claim 7 further comprising one or more solar cells disposed on the housing and wherein one or more of the solar cells re-charges the re-chargeable batteries.

10. The exterminator of claim 1 wherein the exterminator further comprises:
a solar cell power source for the motor, and
a voltage regulator coupled to the solar cell for maintaining a consistent voltage output from the solar cell.

11. The exterminator of claim 1 further comprising:
one or more drainage holes through the base for discharging rain and other moisture from the exterminator.

12. A mechanized exterminator for insects comprising:
a motor having a drive shaft;
a base having a surface;
a support means coupled to the drive shaft and having one or more rollers coupled thereto and disposed in close proximity to the base;
a wind power device for providing power;
a generator coupled to the wind power device and coupled to the motor, the generator converting mechanical energy from the wind power device into electrical energy for the motor; and
wherein the operation of the exterminator in proximity to the insects disturbs the insects causing the insects to get on the surface of the base where the rollers will roll over and crush them.

13. The exterminator of claim 12 further comprising:
one or more batteries for additional power for the motor and/or for voltage regulation of the electrical power to the motor.

14. The exterminator of claim 13 wherein one or more of the batteries is re-chargeable.

15. The exterminator of claim 12 further comprising:
one or more solar cells for additional power for the motor.

16. The exterminator of claim 14 further comprising:
one or more solar cells for additional power for the motor and/or recharging of the re-chargeable batteries.

17. The exterminator of claim 12 further comprising:
one or more drainage holes through the base for discharging rain and other moisture from the exterminator.

18. The exterminator of claim 2 further comprising;
a third piece, said third piece including a wind power device and a generator for converting mechanical energy from the wind power device; and
coupling means for transferring electrical energy from the generator to the motor.

19. The exterminator of claim 12 wherein the wind power device and the generator form a power unit and the motor, base, and support means form a base unit and wherein a single power unit may be used to power a plurality of base units.

20. The exterminator of claim 19 wherein the power unit is remotely located from the base units.
